(19) United States
(12) Patent Application Publication
(10) Pub. No.: US 2012/0038823 A1
(43) Pub. Date: Feb. 16, 2012

(54) DISPLAY SYSTEM

(76) Inventors: Jui-Liang Chien, Taipei City (TW); Chia-Lin Fong, Taipei City (TW); Li-Jen Chao, Taipei County (TW); Chih-Heng Chiu, Taipei City (TW); Chung-Won Shu, Taipei City (TW)

(21) Appl. No.: 12/854,176

(22) Filed: Aug. 11, 2010

(51) Int. Cl. H04N 7/04

(52) U.S. Cl. 348/469; 348/E07.041

(57) ABSTRACT

A display system uses a broadcast device that can receive a plurality of media signals from a plurality of media sources and interlace two or more media signals frame-by-frame to form a display signal with multiplied frequency for being displayed on its panel. A plurality of goggles and corresponding synchronizing devices, selectors, and audio playback components are used in the display system to select and view/listen to each dedicated media signals. Each goggle used by each user is synchronized to turn on by following the timing of its selected media signals so that two or more users who wear dedicated goggles can see different programs on a single broadcast device at the same time.

### BACKGROUND OF THE INVENTION

1. Field of the Invention

The invention relates to a display system, and more particularly, to a display system using multiplied display frequency and frame interchanging technology that can provide more than one media source for two or more users at the same time.

2. Description of the Prior Art

Display systems like TVs, projectors, various kinds of portable devices, can only broadcast one media source at one time based on the conventional display technology. As for follow-up advancement of display technology, picture-in-picture (PIP), where a first program is displayed on a full TV screen and one or more second programs are displayed in inset windows at the same time, or the screen being simply divided into two same-size pictures, often called picture-outside-picture (POP), are invented to provide multiple media sources at the same time. However, the display area of each media source is inevitably reduced to quite an extent for either PIP or POP.

Another technology called “Dual View” is provided presently to provide dual image for exactly two users at the same time, requiring the two users being positioned at two specified angles respectively relative to the display system. With regard to Dual View technology, an additional blocking component must be configured in the display system. Two separate frames from each of the media sources are mixed to form a dual image frame, half-sized in pixels for each frame of the dual image, that is partially blocked by the blocking component so that each user at his/her particular angle is only able to see the corresponding media source. This gives some drawbacks of the Dual View technology: for example, the resolution of each media decreases to its half, only two sources can be provided at the same time, and each media is viewable only with strict angle.

### SUMMARY OF THE INVENTION

The application provides a display system including a broadcast device and a plurality of receiving devices. The broadcast device is utilized for receiving a plurality of media signals from a plurality of media sources and including a processor and a panel. The plurality of media signals from the plurality of media sources are received by the processor and interlaced frame-by-frame by the processor to form a display signal and the panel is utilized for displaying the display signal at a first frequency. Each receiving device includes a goggle for viewing the display signal at a second frequency, and a synchronizing device for controlling the goggle to turn on to view the display signal in synchronous with a media signal selected from the plurality of media sources. The first frequency is n times the second frequency and n equals to a number of the plurality of media signals being interlaced by the processor.

The application also provides a broadcast device. The broadcast device includes a processor and a panel. A plurality of media signals from a plurality of media sources are received by the processor and interlaced frame-by-frame by the processor to form a display signal and the panel is utilized for displaying the display signal. The plurality of media signals received by the processor are from at least two different media sources.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a block diagram of a display system according to this application.

FIG. 2 is a schematic diagram showing that how a plurality of media signals are interlaced frame-by-frame to form a display signal with multiplied display frequency.

### DETAILED DESCRIPTION

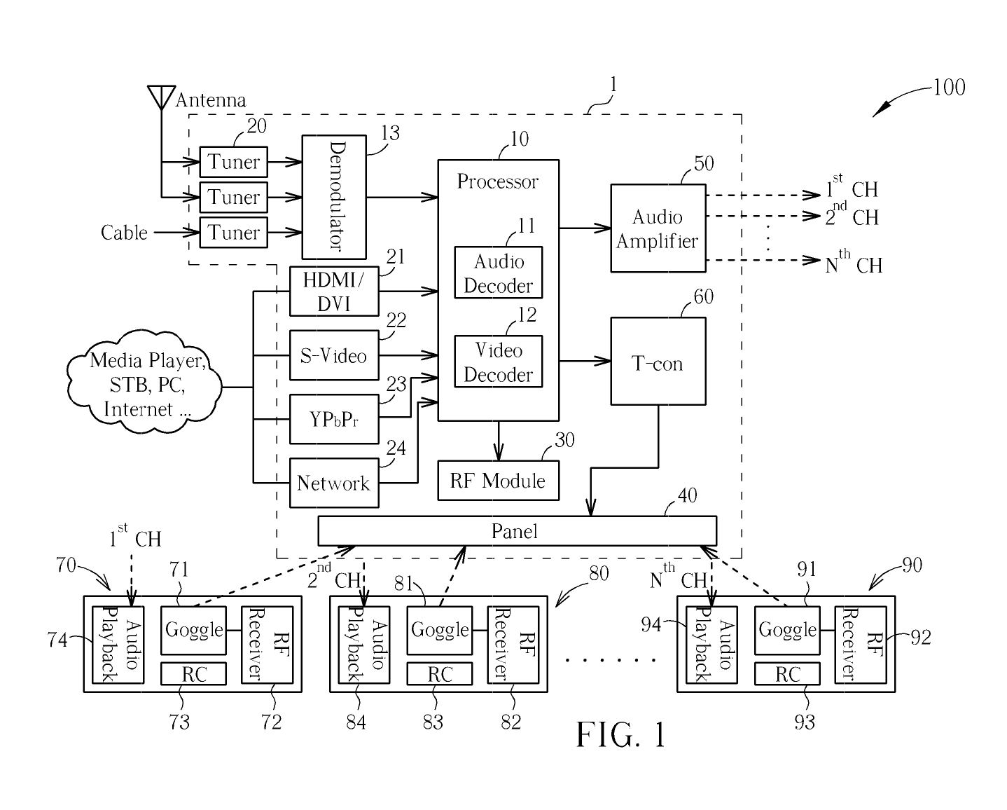

Please refer to FIG. 1. FIG. 1 is a schematic diagram showing a block diagram of a display system 100 according to this application. The display system 100 includes a broadcast device 1 and a plurality of receiving devices 70, 80, 90. The broadcast device 1 practically may be a flat panel television, a projector, or portable devices like mobile TV, portable navigation device (PND), and so on, which provides multimedia content from various sources for users at the same time. Each of the receiving devices 70, 80, 90 is for a single user who watches programs, movies, animations, videos, various sorts of multimedia content, or simply listens to audio contents like music or vocal materials.

The broadcast device 1 includes many kinds of importing ports for receiving a plurality of media signals from a plurality of media sources. A preferred embodiment as illustrated in FIG. 1, the broadcast device 1 includes all or some of a plurality of TV tuners 20, an HDMI/DVI port 21, an S-Video port 22, an YPbPr port 23, and a network port 24. The TV tuners 20 can receive TV programs from either wireless antenna or cable, where the TV programs are then sent for demodulation by a demodulator 13 of the broadcast device 1. The HDMI/DVI port 21, the S-Video port 22, the YPbPr port 23, and the network port 24 can receive media signals from various media sources like media players, set-top boxes (STP), personal computers (PC), and Internet and the media signals are sent to a processor 10 of the broadcast device 1 for decoding by a video decoder 12 of the processor 10. The processor 10 of the broadcast device 1 may receiving the media signals from one or more than one media sources as mentioned above at the same time according to the selections made by the users, where the multiple media signals are interlaced frame-by-frame by the processor 10 to form an outputted display signal.

The broadcast device 1 also includes a time control (T-con) component 60 for controlling the display signal generated by the processor 10 to display on a panel 40 of the broadcast device 1 at a multiplied frequency.

For effectively broadcasting each separate media signal to each separate user from corresponding media source selected by each user, each receiving device includes a synchronizing device that controls the goggle to synchronize with the broadcast device 1 at a specific timing. Take the receiving device 70 for example. The receiving device 70 includes a goggle 71, which is preferably a shutter glass that can be controlled to turn on to allow lights to pass through or turned off to block lights away. The synchronizing device 72 is a wireless receiver, preferably an RF receiver, having control circuit that can receive RF signals and also control the goggle 71. The receiving device 70 also includes a selector 73, practically a remote controller (RC), that can be used by a user to select a media source from the plurality of media sources as mentioned above by transmitting a control signal to the processor 10 of the broadcast device 1, and the processor 10 then receives and processes the media signals of the selected media source according to the control signal. The selector 73 may also provide function of channel selection when the media source selected is a TV program. Once a media source is selected by the selector 73, the processor 10 also generates a synchronizing signal and a wireless transmitter 30, preferably an RF module, transmits the synchronizing signal to the synchronizing device 72 so as to control the goggle 71 to turn on and off at a specific frequency and timing in synchronous with the timing that displays the selected media signals by the panel 40.

Since only the timing of the selected media signals selected by the selector 73 of the receiving device 70 and displayed on the panel 40 is in synchronous with the timing of turning on of the goggle 71, the user who wears the goggle 71 can only see the selected media signals, not being able to see those media signals broadcast by the panel 40 but selected by other selectors.

For audio playback concern, the processor 10 also includes an audio decoder 11 for decoding and processing audio signals received from each media signal of the media sources. The broadcast device 1 utilizes an audio amplifier 50 to broadcast each decoded audio signal in separate channel, say a 1^{st} channel, a 2^{nd} channel, . . . , and an N^{th} channel, each received by its corresponding audio playback component 74, 84, 94 respectively and in synchronous with the media signal selected from the media sources. The audio playback components 74, 84, 94 of the receiving devices 70, 80, 90 are preferably headset earphones that can provide isolated listening condition for each user and the connection between the audio amplifier 50 and each audio playback component 74, 84, 94 can be wireless connected or physically connected. The receiving devices 80, 90 have similar structure and function as the receiving device 70.

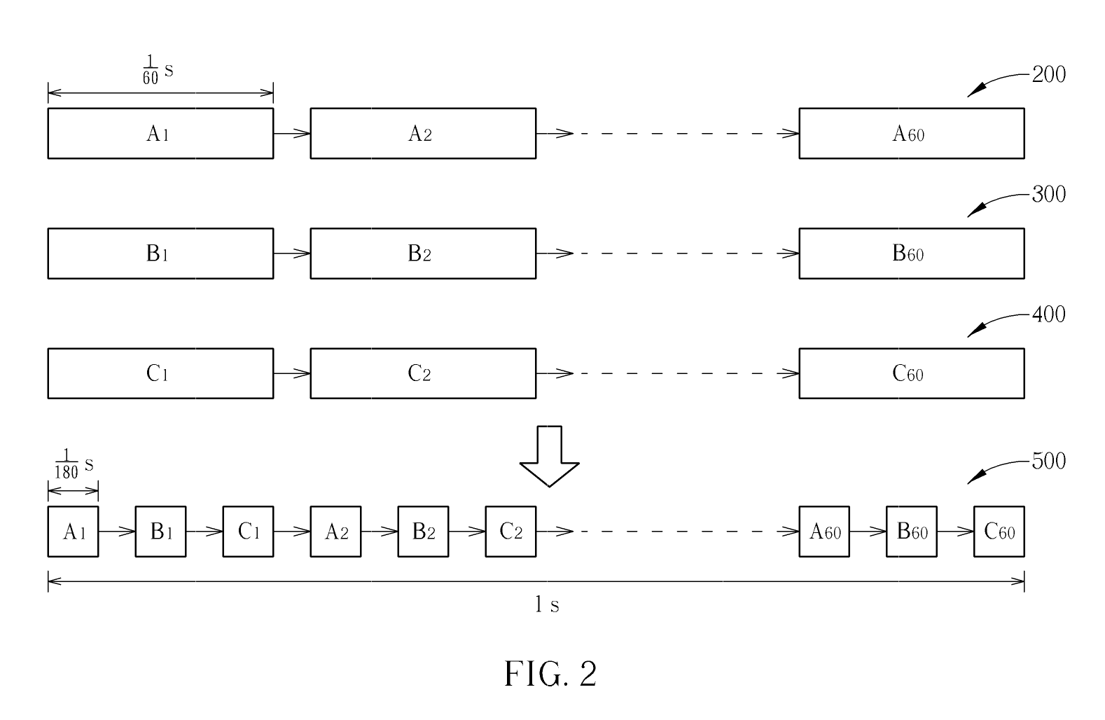

Please refer to FIG. 2, which is a schematic diagram of this application, showing that how a plurality of media signals are interlaced frame-by-frame to form a display signal with multiplied display frequency. The embodiment in FIG. 2 shows that three media signals 200, 300, 400 from three distinct media sources are selected by three users and received by the processor 10 for interlacing with multiplied frequency. Each of the media signals 200, 300, 400 has a generic playback frequency, say 60 Hz, in this embodiment. In other words, each of the media signals 200, 300, 400 provides 60 frames of media signals in one second for the processor 10. The goggles 71, 81, 91 are also turned on to view the display signal at a frequency of 60 Hz, and with shorter turning on interval. By use of the frame-by-frame interlacing technique of this application, the processor 10 receives the three medial signals 200, 300, 400 and interlaces each frame with a same serial number of the three media signals 200, 300, 400 as shown in the display signal 500. As a result, the display signal 500 contains the first frame Al of the media signal 200, the first frame B1 of the media signal 300, the first frame Cl of the media signal 300, the second frame A2 of the media signal 200, the second frame B2 of the media signal 300, the second frame C2 of the media signal 400, . . . , and so on, in a row. The time control (T-con) component 60 then controls the display signal 500 so that each frame is displayed for 1/180 second, which means the panel 40 displays the display signal 500 at a multiplied frequency, say 180 Hz, and that is three time the frequency for each goggle 71, 81, 91 to turn on to view the display signal 500.

As mentioned above, each goggle is controlled by a corresponding synchronizing device. When the panel 40 displays the first frame Al at a first time slot ( 1/180s), the first synchronizing device 72 turns on the first goggle 71 for 1/180 second, a shorter interval as mentioned before, so that the user who wears the first goggle 71 sees the first frame Al through the goggle 71, while at the same time interval, all the other users who wear the goggles 81, . . . , 91 can not see the first frame Al since their goggles 81, . . . , 91 are turned off by their synchronizing devices. When the panel 40 displays the second frame B1 at a second time slot ( 1/180s), the second synchronizing device 82 turns on the second goggle 81 for 1/180 second so that the user who wears the second goggle 81 sees the second frame B1 through the goggle 81. All the frames of the display signal 500 are displayed on the panel 40 and each goggle of the receiving devices is turned on in synchronous with the display timing of its corresponding media signal. Users wearing their own goggles can see different programs from different media sources at the same time by use of the display system disclosed in this application.

The display system of this application uses a broadcast device that can receive media signals from a plurality of media sources and interlace two or more media signals frame-by-frame to form a display signal with multiplied frequency for being displayed on its panel. A plurality of goggles and corresponding synchronizing devices, selectors, and audio playback components are used in the display system to select each dedicated media signals. Each goggle used by each user is synchronized to turn on by following the timing of its selected media signals so that two or more users who wear a dedicated goggle can see different programs on a single broadcast device at the same time.

Those skilled in the art will readily observe that numerous modifications and alterations of the device and method may be made while retaining the teachings of the invention.

What is claimed is:

1. A display system, comprising:
a broadcast device for receiving a plurality of media signals from a plurality of media sources, the broadcast device comprising:
a processor for receiving the plurality of media signals wherein the plurality of media signals from the plurality of media sources are interlaced frame-by-frame by the processor to form a display signal; and
a panel for displaying the display signal at a first frequency; and
a plurality of receiving devices, each receiving device comprising:
a goggle for viewing the display signal at a second frequency; and
a synchronizing device for controlling the goggle to turn on to view the display signal in synchronous with a media signal selected from the plurality of media sources;
wherein the first frequency is n times the second frequency, and n equals to a number of the plurality of media signals being interlaced by the processor.

2. The display system of claim 1, wherein each receiving device further comprises a selector for selecting the media signal provided by one of the plurality of media sources by transmitting a control signal to the processor.

3. The display system of claim 2, wherein the selector is a remote controller.

4. The display system of claim 2, wherein the selector is further utilized for selecting channel of the media signal when the media signal is provided by a TV tuner from the plurality of media sources.

5. The display system of claim 2, wherein the broadcast device further comprises a wireless transmitter for transmitting a synchronizing signal based on the selection made by the selector, and the synchronizing device of each receiving device is a wireless receiver for receiving the synchronizing signal and controlling the goggle to turn on to view the display signal in synchronous with the media signal.

6. The display system of claim 5, wherein the wireless transmitter is an RF module and the wireless receiver of each receiving device is an RF receiver.

7. The display system of claim 1, wherein the broadcast device further comprises a demodulator for demodulating the media signals when the media signals are provided by TV tuners.

8. The display system of claim 1, wherein the processor comprises a video decoder for decoding the media signals.

9. The display system of claim 1, wherein the broadcast device further comprises a time control (T-con) component for controlling the display signal to display on the panel at the first frequency.

10. The display system of claim 1, wherein the processor comprises an audio decoder for decoding the audio signals of the media signals, the broadcast device further comprises an audio amplifier for broadcasting each decoded audio signal in separate channel, and each receiving device further comprises an audio playback component for receiving and playing the audio signal of corresponding channel in synchronous with the media signal selected from the plurality of media signals.

11. The display system of claim 1, wherein the goggle of each receiving device is a shutter glass.

12. The display system of claim 1, wherein the broadcast device comprises a TV tuner, an HDMI/DVI port, an S-Video port, a YPbPr port, or a network port for receiving media signals from cable/wireless TV program provider, networks, media players, set-top boxes (STPs), or personal computers.

13. The display system of claim 1, wherein the second frequency is 60 Hz.

14. A broadcast device comprising:
a processor for receiving a plurality of media signals from a plurality of media sources, wherein the plurality of media signals are interlaced frame-by-frame by the processor to form a display signal; and
a panel for displaying the display signal;
wherein the plurality of media signals received by the processor are from at least two different media sources.

15. The broadcast device of claim 14, further comprising a demodulator for demodulating the media signals when the media signals are provided by TV tuners.

16. The broadcast device of claim 14, wherein the processor comprises a video decoder for decoding the media signals.
